(19) United States
(12) Patent Application Publication
(10) Pub. No.: US 2006/0190559 A1
(43) Pub. Date: Aug. 24, 2006

(54) Multimedia contents moving method and system

(75) Inventor: Hun Lim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/312,384

(22) Filed: Dec. 21, 2005

(30) Foreign Application Priority Data
Feb. 17, 2005 (KR) 10-2005-0012981

(51) Int. Cl. G06F 15/16

(52) U.S. Cl. 709/217

(57) ABSTRACT

Multimedia contents moving method and system. In a multimedia system including a media server for transmitting media data, at least one multimedia device for playing the media data and at least one controller for controlling the multimedia device, the method includes the steps of: sending a copy command to a first multimedia device using the controller; sending the copy command to the media server from the first multimedia device; sending a play-stop command to the first multimedia device from the multimedia server; storing a current play location of the multimedia data by the media server; sending a paste command from the controller to a second multimedia device so as for the second multimedia device to play the later part of the multimedia data which was being played by the first multimedia device, and sending the paste command from the second multimedia device to the media server; and transmitting the media data from the media server to the second multimedia device. A user can continuously use the multimedia contents using different kinds of multimedia devices by simply operating a controller while moving around, that is, moving from a place to a different place, in a home network system, even in a case where the user moves from a place to a different place.

### CROSS-REFERENCE TO RELATED APPLICATIONS.

This application claims priority from Korean Patent Application No. 10-2005-0012981 filed on Feb. 17, 2005 in the Korean Intellectual Property Office, the entire content of which is incorporated herein by reference.

### BACKGROUND OF THE INVENTION

1. Field of the Invention

Methods and apparatuses consistent with the present invention relates to moving multimedia contents, and more particularly to moving multimedia contents being enjoyed by a user from a multimedia device to a different multimedia device by copying and pasting the multimedia contents using a portable controller.

2. Description of the Related Art

With the spread of the Internet using a high-speed network and rapid progress in information technologies (IT), a network environment which has been established to be adaptive for corporate or public offices is spreading to home digital appliances. Accordingly, a home network industry and its relational apparatus are being paid more attention and given higher interest. Generally, such a home network system includes a plurality of multimedia devices which have different media types and resolutions and need different formats of media data. Accordingly, there is a problem that the multimedia devices in a home network system can not share multimedia contents or media data (media source). In a home network system, in a case where a user moves from a first place to a second place and wants to continuously enjoy the specified multimedia contents being enjoyed by the user in the first place, by using a multimedia device installed in the second place, there is a problem that the user has to select the multimedia device adaptive to the multimedia contents enjoyed by the user and operate the multimedia device by himself or herself to continuously enjoy the multimedia contents.

### SUMMARY OF THE INVENTION

The present invention has been developed in order to solve the above and other problems associated with the related art. An aspect of the present invention is to provide a method of and a system for moving multimedia contents from a multimedia device to a different device by copying and pasting multimedia contents using a portable controller.

In order to achieve an aspect of the present invention, there is provided a method of moving multimedia contents in a multimedia system including a media server for transmitting media data, at least one multimedia device for playing the media data and at least one controller for controlling the multimedia device, the method including the steps of: sending a copy command to a first multimedia device using the controller; sending the copy command to the media server from the first multimedia device; sending a play-stop command to the first multimedia device from the multimedia server; storing a current play location of the multimedia data by the media server; sending a paste command from the controller to a second multimedia device so as for the second multimedia device to play the later part of the multimedia data which was being played by the first multimedia device, and sending the paste command from the second multimedia device to the media server; and transmitting the media data from the media server to the second multimedia device.

In an exemplary embodiment of the present invention, the first multimedia device sends its own identification symbol to the media server after sending the copy command to the media server.

In another exemplary embodiment of the present invention, the second multimedia device in the multimedia system sends its own identification symbol to the media server after sending the paste command to the media server.

In another exemplary embodiment of the present invention, the method further includes the step of checking and confirming that the first multimedia device stopped playing the media data, and updating status information of the first multimedia device after the first multimedia device stopped playing the media data by the play-stop command.

In another exemplary embodiment of the present invention, the method further includes the step of converting the media data so as to be played in the second multimedia device, wherein the converting is performed by the media server.

In another exemplary embodiment of the present invention, the step of converting includes converting a format of the media data to be adaptive to the second multimedia device; and converting a resolution of the media data to be adaptive to the second multimedia device.

In another exemplary embodiment of the present invention, in the step of sending the copy command, the controller checks whether the media server executed the copy command, and then displays a message representing the copy command execution status.

In another exemplary embodiment of the present invention, in the step of sending the paste command to the media server, the controller checks whether the media server executed the paste command, and displays a message representing the paste command execution status.

In another exemplary embodiment of the present invention, the system includes two or more controllers provided with respective identification symbols, and the media server manages commands sent by the controllers and command executions for respective controllers separately for each identification symbol.

In another exemplary embodiment of the present invention, the step of sending the copy command includes: checking whether a user is around the first multimedia device using a sensor attached to the first multimedia device; and instructing the controller to send the copy command wherein the instructing is performed by the sensor attached to the first multimedia device.

In another exemplary embodiment of the present invention, the step of sending the paste command includes: checking whether a user is around the second multimedia device by a sensor attached to the second multimedia device; and instructing the controller to send the paste command wherein the instructing is performed by the sensor attached to the second multimedia device.

In order to achieve another aspect of the present invention, there is provided a multimedia contents moving system, including: a media server for transmitting multimedia contents; at least one multimedia device for playing the multimedia contents; and at least one controller for controlling the multimedia device, wherein the controller sends a copy command and a paste command to the multimedia device, a first multimedia device out of the at least one multimedia device receives the copy command from the controller, sends the copy command to the media server and stops playing the multimedia contents therein after receiving a play-stop command from the media server, a second multimedia device out of the at least one multimedia device receives the paste command from the controller, sends the paste command to the media server, receives media data from the media server and plays the media data transmitted, and the media server sends the play-stop command to the first multimedia device and transmits the media data to the second multimedia device.

In an exemplary embodiment of the present invention, the controller includes a displaying part for displaying a message representing either copy command execution status or phase command execution status.

In another exemplary embodiment of the present invention, the system includes two or more controllers.

In another exemplary embodiment of the present invention, the media server is incorporated into the controller.

In another exemplary embodiment of the present invention, the first multimedia device has a sensor to check whether a user is around the first multimedia device and instruct the controller to send the copy command.

In another exemplary embodiment of the present invention, the second multimedia device has a sensor to check whether a user is around the second multimedia device and instruct the controller to send the paste command.

### BRIEF DESCRIPTION OF THE DRAWINGS

The above and other aspects of the present invention will be more apparent by describing exemplary embodiments of the present invention with reference to the accompanying drawings, in which:

FIG. 1 is a view showing a configuration of a multimedia contents moving system in accordance with an exemplary embodiment of the present invention;

FIG. 2 illustrates functional parts of the multimedia contents moving system in accordance with an exemplary embodiment of the present invention;

FIG. 3 is a message sequence chart provided to explain the operation method of the multimedia contents moving system in accordance with an exemplary embodiment of the present invention;

FIG. 4 is a flow chart for showing a process of checking whether a device is operable and a data conversion process in the multimedia contents moving system in accordance with an exemplary embodiment of the present invention;

FIG. 5 is a flow chart showing a multimedia contents moving method in accordance with an exemplary embodiment of the present invention;

FIG. 6 is a flow chart showing a multimedia contents moving method in accordance with another exemplary embodiment of the present invention; and

FIG. 7 is a flow chart showing a multimedia contents moving method in accordance with another exemplary embodiment of the present invention.

### DETAILED DESCRIPTION OF EXEMPLARY EMBODIMENTS

Exemplary embodiments of the present invention will be described in greater detail with reference to the accompanying drawings.

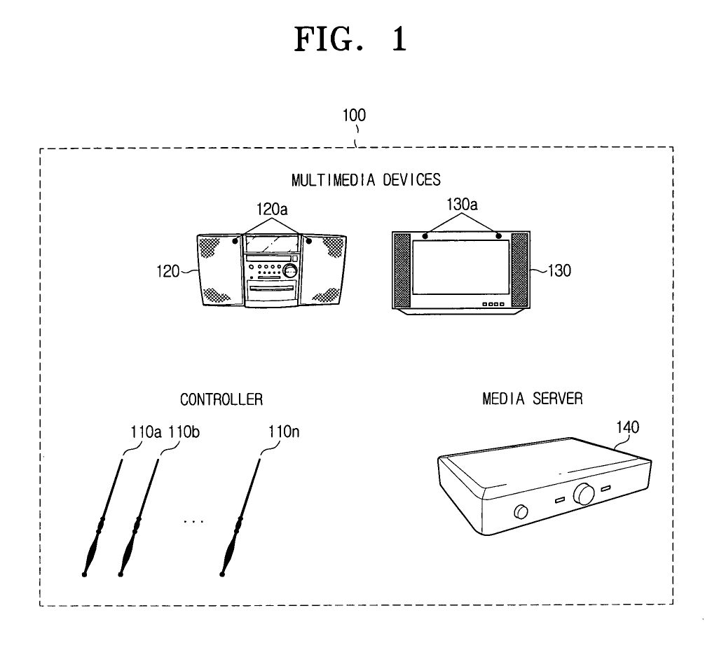

FIG. 1 illustrates a configuration of a multimedia contents moving system in accordance with an exemplary embodiment of the present invention. Referring to FIG. 1, a multimedia contents moving system (100) in accordance with an exemplary embodiment of the present invention includes a plurality of multimedia devices 120 and 130, a media server 140 and controllers 110a to 110n.

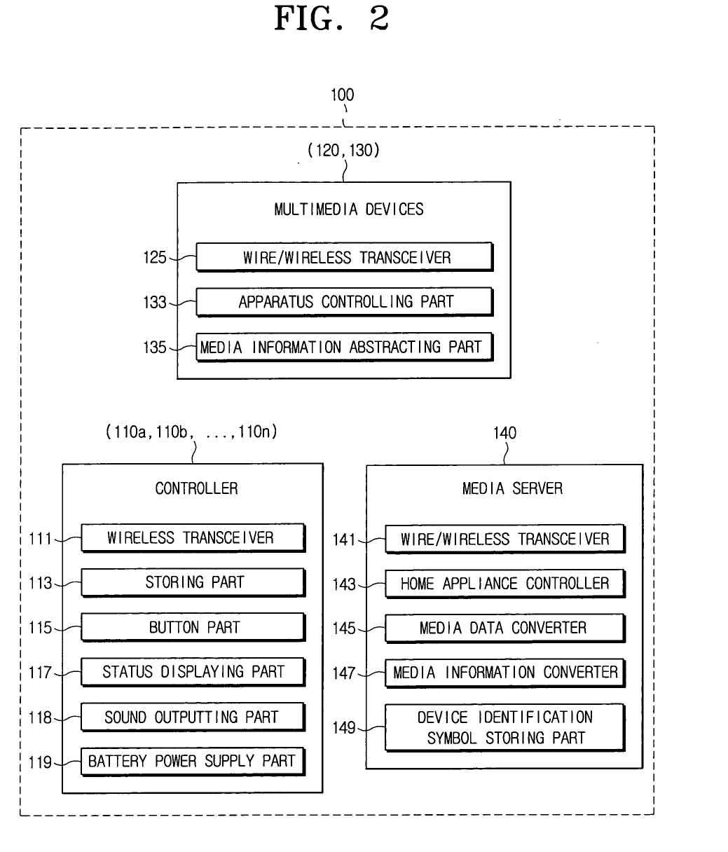

FIG. 2 illustrates functional blocks of each element in the multimedia contents moving system (100) in accordance with an exemplary embodiment of the present invention. Referring to FIG. 2, the multimedia devices 120 and 130 include a wire/wireless transceiver 125, an apparatus controlling part 133, and a media information abstracting part 135. The media server 140 includes a wire/wireless transceiver 141, a home appliance controller 143, a media data converter 145, a media information converter 147 and a device identification symbol storage part 149. The controllers 110a to 110n include a wireless transceiver 111, a storing part 113, a button part 115, a status displaying part 117, a sound outputting part 118 and a battery power supply part 119.

A device information storing part 149 of the media server stores the device's functional information, which includes a device identification symbol, a connection means such as WLAN, RGB, etc., an audio applicability, a video applicability, an image applicability, a format such as MPEG2, MP3, WAV, etc., and a resolution such as 1000×768, 64 kbps, and a device status information, which includes a device identification symbol, a device's operation status such as power on/off, play, stop, pause, etc., and media data. The media data includes a media identification symbol, a media type such as audio, video and image, a format such as MPEG, MP3, WAV, etc. Such information is needed to transfer media data adaptive to a multimedia device.

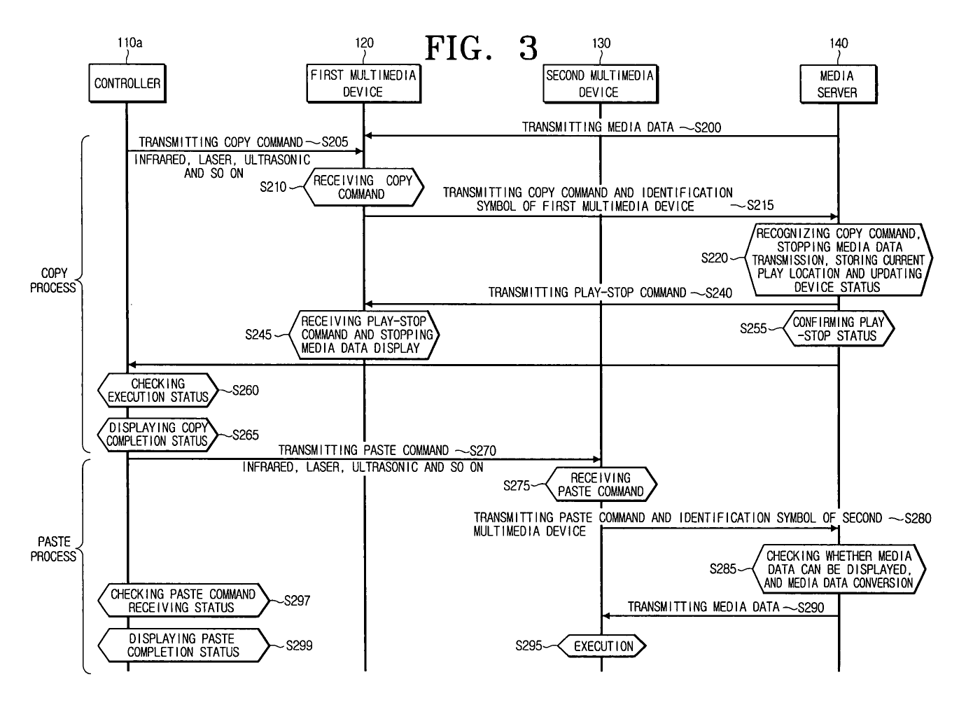

FIG. 3 illustrates a sequence chart provided to explain the operational method of the multimedia contents moving system in accordance with an exemplary embodiment of the present invention. The multimedia contents moving system in accordance with an exemplary embodiment of the present invention will be described in more detail with reference to FIG. 3. The media server 140 transmits media data to a first multimedia device 120 (S200), and the first multimedia device 120 plays the media data transmitted from the media server 140. One of the controllers 110a sends a copy command to the first multimedia device 120 using infrared, laser, ultrasonic and so on (S205).

The first multimedia device 120 receives the copy command (S210), and sends the received copy command and its own identification symbol to the media server 140 (S215). The media server 140 recognizes the copy command, stops transmitting media data to the first multimedia device 120, stores the current play location of the media data being transmitted to the first multimedia device 120 and updates the operation status information of the first multimedia device 120 by replacing status “play” with status “stop” after receiving the copy command and the device identification symbol (S220).

The media server 140 sends a play-stop command to the first multimedia device 120 (S240), and the first multimedia device 120 stops playing the media data after receiving the play-stop command (S245). The media server 140 checks the operation status of the first multimedia device 120 and confirms that the first multimedia device 120 stopped playing the media data (S255). Meanwhile, the controller 110a checks whether the media server 140 executed the copy command completely (S260) and displays a message (S265) representing the execution status of the copy command of the media server 140 using the status displaying part 117 thereof.

Then, the controller 110a sends a paste command to a second multimedia device 130 (S270), and the second multimedia device 130 receives the paste command (S275) and sends the paste command and its own device identification symbol to the media server 140 (S280). The media server 140 checks the operational status of the second multimedia device 130, that is, checks whether the second multimedia device 130 can play the media data using the device identification symbol of the second multimedia device 130 and performs data conversion (S285).

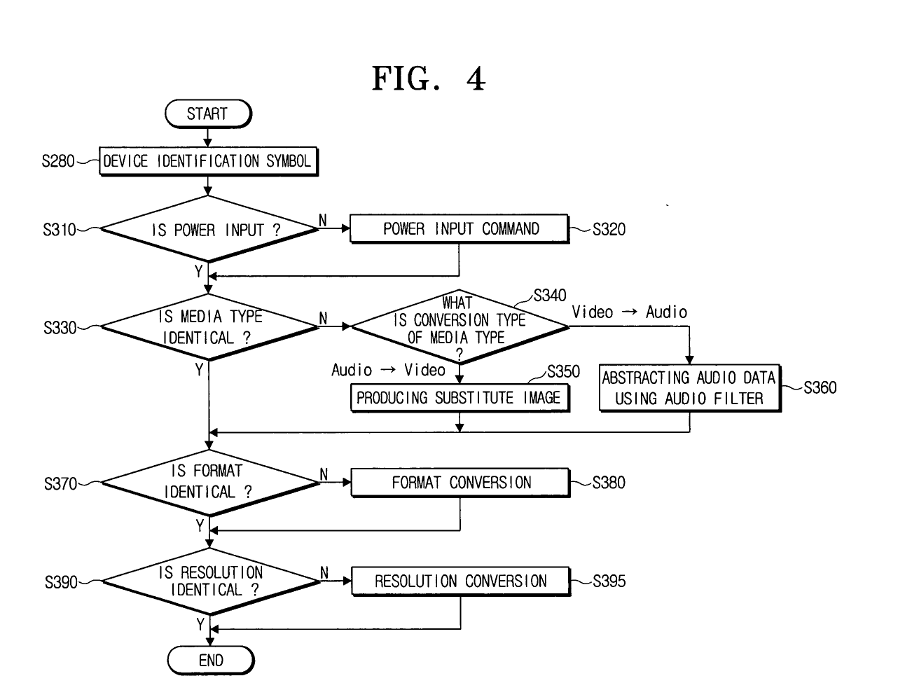

FIG. 4 is a flow chart showing the order of checking whether the multimedia device can play the media data and the order of data conversion procedure. First, the media server 140 checks whether the second multimedia device 130 is powered on from the status information of the second multimedia device 130 (S310), and generates a power input command so as for the second multimedia device 130 to be powered on (S320) in case that the power is not supplied to the second multimedia device 130. Next, when the second multimedia device 130 becomes power-on status, the media server 140 checks whether a media type of media data transmitted to the first multimedia device 120 is identical to a media type of the media data to be transmitted to the second multimedia device 130 (S330).

In a case where the media types are not identical, a conversion type of the media type to be converted is checked (S340). Here, in a case where the media type of the media data transmitted to the first multimedia device 120 is an audio and the media type of the media data to be transmitted to the second multimedia device 130 is a video, a substitute image is produced through the data conversion procedure (S350).

On the contrary, in a case where the media types of the media data transmitted to the first multimedia device 120 and the media data to be transmitted to the second multimedia device 130 are video and audio, respectively, audio data is abstracted from the media data transmitted to the first multimedia device 120 using an audio filter (S360). Next, it is checked whether a format of the media data transmitted to the first multimedia device 120 is identical to a format of the media data to be transmitted to the second multimedia device 130 (S370). In a case where the formats are different from each other, the media data format is converted to be adaptive to the second multimedia device 130 (S380).

Next, resolutions of the first and second multimedia devices 120, 130 are compared (S390). In a case where the resolutions are different, a resolution of the media data transmitted to the first multimedia device 120 is converted to be adaptive to the second multimedia device 130 (S395).

Process steps subsequent to the step of checking whether the device can be operated and the step of data conversion, which is discussed with reference to FIG. 4, will be described with reference to FIG. 3. After checking whether the second multimedia device 130 is on the operable status and performing the data conversion, the controller 110a checks whether the media server 140 receives the paste command (S297). Next, the controller 110a displays the paste command reception status (S299) using the status displaying part 117 and the media server 140 sends the media data to the second multimedia device 130 (S290). Then, the second multimedia device 130 plays the media data (S295).

In accordance with an exemplary embodiment of the present invention, the system includes two or more controllers 110a, 110b, . . . , 110n instead of only one controller 110a. In a case where the system includes a plurality of controllers 110a, 110b, . . . , and 110n, each controller is provided with its own identification symbol. Accordingly, the media server 140 manages commands which are transmitted and executions with respect to the commands for each controller using the controller identification symbols. Thus, the operations are performed independently by the controllers 110a, 110b, and 110n.

In accordance with another exemplary embodiment of the present invention, the media server 140 can be incorporated into the controller 110a. In a case where the media server 140 is incorporated into the controller 110a, the steps of checking the execution status of the copy command and the paste command are unnecessary.

In accordance with another exemplary embodiment of the present invention, sensors 120a and 130a are attached to the first multimedia device 120 and the second multimedia device 130, respectively. In a case where a user moves from a place where a first multimedia device 120 is installed to a different place, the sensor 120a attached to the first multimedia device 120 detects that the user is not in the place where the first multimedia device 120 is installed, that is, the user is not around the first multimedia device 120, generates a signal representing that the user is not around the first multimedia device 120, and transmits the signal to the controller 110a. When the controller 110a receives the signal, the controller 110a sends a copy command to the first multimedia device 120 (S205).

Meanwhile, the sensor 130a attached to the second multimedia device 130 detects that the user is in the different place, that is the user is around the second multimedia device 130, generates a signal representing user's existence, and transmits the signal to the controller 110a. When the controller 110a receives the signal notifying the user's existence, it sends a paste command to the second multimedia device 130 (S270).

The controller 110a, the first multimedia device 120, the second multimedia device 130, the sensors 120a and 130a and the media server 140 use a wire communication method or a wireless communication method for communication there between depending on the network environment. When the controller 110a sends the copy command and the paste command (S205, S270), it can use infrared light, ultrasonic wave, a laser, etc.

Next, a method of and a system for moving multimedia contents in accordance with another exemplary embodiment of the present invention are as follows:

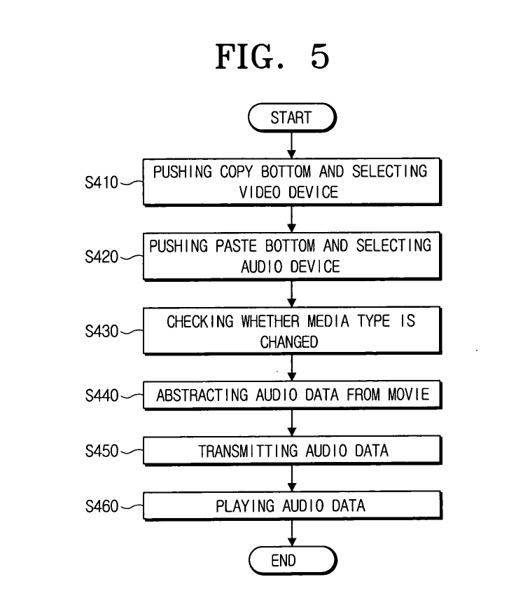

FIG. 5 illustrates a flow chart showing a method for moving multimedia contents in accordance with the exemplary embodiment of the present invention. Referring to FIG. 5, a case where a user wants to change a type of multimedia contents to enjoy, that is, a user initially enjoys video contents and then wants to enjoy audio contents instead of the video contents will be discussed. There is a case where a user is enjoying a movie using a multimedia device capable of playing video contents as multimedia data transmitted from the media server 140 in a room, and then, the user wants to continuously hear only sound of the movie using a multimedia device capable of playing audio contents in a living room. In such a case, the user pushes a copy button provided to the controller 110a and selects a video device as a media type of a multimedia device currently being used (S410). Then, the user moves to the living room, pushes a paste button provided to the controller 110a in the living room and selects an audio device as a media type of a multimedia device to use (S420). The media server 140 checks whether the media type should be changed (S430) through the data conversion process (S285) and abstracts audio data from the movie, the video contents (S440). The abstracted audio data is transmitted to the audio device (S450) and the audio device in the living room plays the audio data transmitted (S460). As a result, audio sound of the movie enjoyed by the user in the room is output from the audio device in the living room.

In the case above, if sensors 120a and 130a are attached to the video device 120 and the audio device 130, respectively, the operation of the system will be as follows:

If the user goes out the room, the sensor 120a attached to the video device detects that the user is not in the room, i.e. around the video device, and sends an instruction signal of copy command signal to the controller 110a. When the user appears in the living room, the sensor 130a attached to the audio device 130 detects that there is the user in the living room, i.e. around the audio device, and sends an instruction signal of paste command signal to the controller 110a.

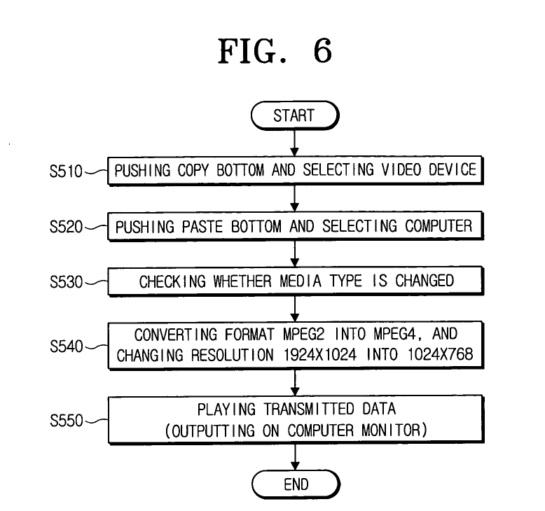

FIG. 6 is a flow chart showing a multimedia contents moving method in accordance with another exemplary embodiment of the present invention. There is a case that a user is watching a movie using a video device capable of playing media data transmitted from the media server 140 in a room and wants to continuously watch the later part of the movie using a computer in the user's study. In such a case, the multimedia contents moving method in accordance with an exemplary embodiment of the present invention will be discussed. First, the user pushes a copy button of the controller 110a and selects a video device as a media type of a multimedia device currently being used using the controller 110a (S510) and then moves to the user's study. Then, the user pushes a paste button on the controller 110a and selects a computer as a media type of a multimedia device to use in the study (S520). The media server 140 checks whether the media types are different (S530) and converts the media data from a video adaptive format, MPEG2, to a computer monitor adaptive format, MPEG4 through the format conversion procedure. Then, the media server 140 changes a resolution of the media type from a video resolution, for example 1924×1024, to a computer monitor resolution, for example 1024×768 through the resolution conversion procedure (S540) if needed. The converted media data is transmitted to the computer and then played by the computer in the user's study (S550), so that the user can continuously enjoy the movie, which the user watched using the video device in the room, now using the computer in the user's study room. In such a case, if the video device and the computer have sensors, respectively, the media contents moving method will be as follows:

If the user goes out the room, a sensor provided to the video device detects that the user is not in the room and instructs the controller 110a to send a copy command to the media server 140 (S205). If the user goes into his/her study, the sensor provided to the computer in the study detects that there is the user around the computer and instructs the controller 110a to send a paste command (S270) to the media server 140.

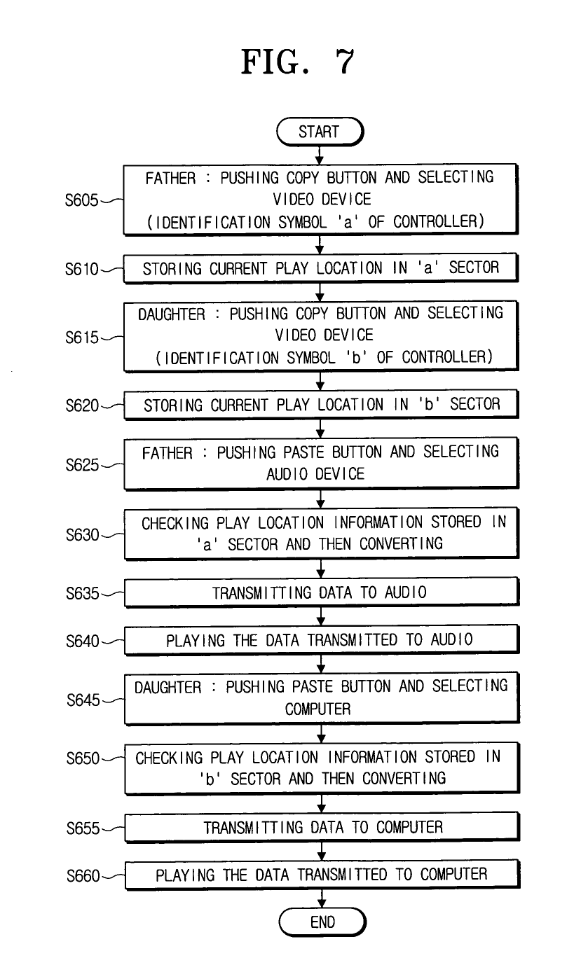

FIG. 7 is a flow chart showing a method of moving multimedia contents in accordance with another exemplary embodiment of the present invention. Referring to FIG. 2, a case with two users will be discussed. A father and his daughter are watching a movie using a video device in a room, and then the father pushes a copy button on his controller 110a and selects a video device as a media type in the room (S605). Then, the media server recognizes a signal from the controller 110a and stores a current play location using an identification symbol “a” of the controller 110a (S610).

After a lapse of a predetermined time, the daughter pushes a copy button on her controller 110b and selects a video device as a media type of a multimedia device which she has used (S615). The media server recognizes a signal from the controller 110b and stores a current play location with an identification symbol “b” into a different sector from a sector storing the current play location information regarding the identification symbol “a” (S620).

Then, the father comes to a living room, and pushes a button on his controller 110a and selects an audio device to be used (S625). The media server 140 recognizes an identification symbol with respect to the paste command signal from the father's controller 110a. Then, the media server checks the play location information stored in the section corresponding to the identification symbol “a”, and transmits converted media data to the audio device in the living room (S630 and S635). Then, the media data is played by the audio device in the living room. That is, audio sound of the movie watched by the father in the room is output from the audio device in the living room.

Meanwhile, the daughter goes into her study, and pushes a button on her controller 110b to select a computer as the media type to be used (S645). The media server recognizes the identification symbol with respect to the paste command signal from the daughter's controller 110b. The media server checks the play location information stored in the sector corresponding to the identification symbol “b” (S650), converts the media data, and transmits the converted media data to the computer (S655). As a result, the daughter can watch continuously the movie which she watched in the room.

As described above, in accordance with an exemplary embodiment of the present invention, multimedia device users can continuously use multimedia contents, which they enjoyed by themselves in a place, after moving to a different place within a home network system using a different a multimedia device with only a simple operation of a controller. Further, since it is possible to independently control the multimedia system using a plurality of controllers, many users can share the media contents by independently moving the multimedia contents to different multimedia devices. Further, it is possible to continuously enjoy the multimedia contents without any additional operations using a controller while moving around in a space where the multimedia system is installed.

The foregoing embodiments and aspects are merely exemplary and are not to be construed as limiting the present invention. The present teaching can be readily applied to other types of embodiments. Also, the description of the exemplary embodiments of the present invention is intended to be illustrative, and not to limit the scope of the claims, and many alternatives, modifications, and variations will be apparent to those skilled in the art.

What is claimed is:

1. A method of moving multimedia contents in a multimedia system which includes a media server that transmits media data, at least one multimedia device that plays the media data and at least one controller that controls the at least one multimedia device, the method comprising:
sending a copy command to a first multimedia device using a first controller;
sending the copy command to the media server from the first multimedia device;
sending a play-stop command to the first multimedia device from the media server;
storing a current play location of the media data by the media server;
sending a paste command from the first controller to a second multimedia device so as to enable the second multimedia device to play a later part of the multimedia data which was being played by the first multimedia device, and sending the paste command from the second multimedia device to the media server; and
transmitting the media data from the media server to the second multimedia device.

2. The method according to claim 1, wherein the first multimedia device sends its own identification symbol to the media server after sending the copy command to the media server.

3. The method according to claim 1, wherein the second multimedia device in the multimedia system sends its own identification symbol to the media server after sending the paste command to the media server.

4. The method according to claim 1, further comprising checking and confirming that the first multimedia device stopped playing the media data in response to the play-stop command, and updating status information of the first multimedia device after the first multimedia device stopped playing the media data.

5. The method according to claim 1, further comprising converting the media data so as to be played in the second multimedia device, wherein the converting is performed by the media server.

6. The method according to claim 5, wherein converting the media data comprises:
converting a format of the media data to be adaptive to the second multimedia device; and
converting a resolution of the media data to be adaptive to the second multimedia device.

7. The method according to claim 1, wherein in sending the copy command, the controller checks whether the media server executed the copy command, and then displays a message representing a copy command execution status.

8. The method according to claim 1, wherein in sending the paste command to the media server, the controller checks whether the media server executed the paste command, and displays a message representing a paste command execution status.

9. The method according to claim 1, wherein the multimedia system includes two or more controllers provided with respective identification symbols, and the media server manages commands sent by the two or more controllers and command executions for respective controllers separately for each identification symbol.

10. The method according to claim 1, wherein sending the copy command comprises:
checking whether a user is near the first multimedia device using a sensor attached to the first multimedia device; and
instructing the first controller to send the copy command, wherein the instructing the first controller to send the copy command is performed by the sensor attached to the first multimedia device.

11. The method according to claim 1, wherein sending the paste command comprises:
checking whether a user is near the second multimedia device using a sensor attached to the second multimedia device;
instructing the first controller to send the paste command wherein the instructing the first controller to send the paste command is performed by the sensor attached to the second multimedia device.

12. The method according to claim 1, further comprising sending another copy command to one of the at least one multimedia device from a second controller.

13. A multimedia contents moving system, comprising:
a media server which transmits multimedia contents;
at least one multimedia device which plays the multimedia contents; and
at least one controller which controls the at least one multimedia device,
wherein a first controller sends a copy command and a paste command to a first multimedia device out of the at least one multimedia device, the first multimedia device receives the copy command from the first controller, sends the copy command to the media server and stops playing the multimedia contents therein after receiving a play-stop command from the media server, a second multimedia device out of the at least one multimedia device receives the paste command from the first controller, sends the paste command to the media server, receives media data from the media server and plays the media data transmitted from the media server, and the media server sends the play-stop command to the first multimedia device and transmits the media data to the second multimedia device.

14. The system according to claim 13, wherein the first controller includes a displaying part which displays a message representing either copy command execution status or phase command execution status.

15. The system according to claim 13, wherein the system includes two or more controllers.

16. The system according to claim 13, wherein the media server is incorporated into the first controller.

17. The system according to claim 13, wherein the first multimedia device has a sensor to check whether a user is near the first multimedia device and instruct the first controller to send the copy command.

18. The system according to claim 13, wherein the second multimedia device has a sensor to check whether a user is near the second multimedia device and instruct the first controller to send the paste command.

19. The system according to claim 13, further comprising a second controller which sends a copy command to one of the at least one multimedia device.
